(19) United States
(12) Patent Application Publication
(10) Pub. No.: US 2015/0181168 A1
(43) Pub. Date: Jun. 25, 2015

(54) INTERACTIVE QUALITY IMPROVEMENT FOR VIDEO CONFERENCING

(71) Applicant: DDD IP Ventures, Ltd., Road Town (VG)

(72) Inventors: Peshala Vishvajith Pahalawatta, Glendale, CA (US); Kevin John Stec, Los Angeles, CA (US)

(21) Appl. No.: 14/575,874

(22) Filed: Dec. 18, 2014

Related U.S. Application Data
(60) Provisional application No. 61/919,589, filed on Dec. 20, 2013.

(51) Int. Cl. H04N 7/15; H04N 19/80; G06K 9/00; G06K 9/46; G06T 7/00

(52) U.S. Cl. CPC H04N 7/155; G06K 9/4671; G06T 7/0051; G06K 9/00624; H04N 19/80

(57) ABSTRACT

An apparatus and method are provided to allow users of a device for video conferencing operating in a very low bandwidth environment to touch or gesture to an object or region of the image that they would like to see with improved quality. The feedback is then sent to the transmitting end where the selected region is encoded with higher quality parameters while other regions are pre-processed and encoded with fewer bits. Depth information, available through a depth camera or other method, may be used to determine the boundary of the selected object as well as to perform depth-based saliency detection and pre-processing of the image in order to reduce the overall required bandwidth.

### CROSS REFERENCE TO RELATED APPLICATIONS

This application claims priority to U.S. Provisional Application No. 61/919,589, entitled “INTERACTIVE QUALITY IMPROVEMENT FOR VIDEO CONFERENCING,” and filed Dec. 20, 2013, the entirety of which is hereby incorporated by reference.

### FIELD

Certain aspects of the present disclosure generally relate to video conferencing. More specifically, the disclosure is directed to devices, systems, and methods related to interactive quality improvements for video conferencing.

### BACKGROUND

Video conferencing, especially over mobile wireless devices, is a particularly difficult problem because it requires transmitting video information using limited bandwidth. Certain video conferencing systems suffer from frequent interruptions and image degradation to the point of unintelligibility. Accordingly, improvements are needed to solve the problem of video quality degradation in low bandwidth video conferencing.

### SUMMARY

Various implementations of systems, methods and devices within the scope of the appended claims each have several aspects, no single one of which is solely responsible for the desirable attributes described herein. In this regard, embodiments of the present invention may be embodied in many different forms and should not be construed as being limited to the embodiments set forth herein. Without limiting the scope of the appended claims, some prominent features are described herein.

An apparatus for communicating video information is provided. The apparatus comprises a memory unit configured to receive and store regional information and depth information of the video information. The regional information is selected at a display device and indicates at least a first region and a second region of an image of the video information. The apparatus further comprises a processing circuit configured to determine depth-based saliency information of the video information based on the regional information and the depth information. The processing circuit is further configured to process the first region at a first compression level based on the depth-based saliency information. The processing circuit is further configured to process the second region at a second compression level based on the depth-based saliency information. A first image quality of the first compression level is higher than a second image quality of the second compression level.

A method for communicating video information is also provided. The method comprises receiving and storing regional information and depth information of the video information. The regional information is selected at a display device and indicates at least a first region and a second region of an image of the video information. The method further comprises determining depth-based saliency information of the video information based on the regional information and the depth information. The method further comprises processing the first region at a first compression level based on the depth-based saliency information. The method further comprises processing the second region at a second compression level based on the depth-based saliency information. A first image quality of the first compression level is higher than a second image quality of the second compression level.

An apparatus for communicating video information is also provided. The apparatus comprises means for receiving and storing regional information and depth information of the video information. The regional information is selected at a display device and indicates at least a first region and a second region of an image of the video information. The apparatus further comprises means for determining depth-based saliency information of the video information based on the regional information and the depth information. The apparatus further comprises means for processing the first region at a first compression level based on the depth-based saliency information. The processing means is further configured to process the second region at a second compression level based on the depth-based saliency information. A first image quality of the first compression level is higher than a second image quality of the second compression level.

### BRIEF DESCRIPTION OF THE DRAWINGS

FIG. 1 shows a video conferencing system comprising a first user device and a second user device configured to perform video conferencing.

FIG. 2 shows a functional block diagram of components that may be utilized in the user device of FIG. 1 to perform interactive quality improvement for video conferencing.

FIG. 3 shows a functional block diagram of the sensor of FIG. 2 for detecting a user interaction and providing feedback information.

FIG. 4 shows a functional block diagram of the processor of FIG. 2 for receiving feedback information, depth information, video information, and the video encoder of FIG. 2 for providing encoded video information.

FIG. 5 shows a functional block diagram of the video analyzer of FIG. 4 for determining depth-based saliency information based on the feedback information.

FIG. 6 shows a functional block diagram of the video pre-processor of FIG. 4 for providing pre-processed video information based on the depth-based saliency information.

FIG. 7 shows a flow chart of a method for communicating video information to a display device.

### DETAILED DESCRIPTION

Various aspects of the novel systems, apparatuses, and methods are described more fully hereinafter with reference to the accompanying drawings. The teachings of the disclosure may, however, be embodied in many different forms and should not be construed as limited to any specific structure or function presented throughout this disclosure. Rather, these aspects and embodiments are provided so that this disclosure will be thorough and complete, and will fully convey the scope of the disclosure. The scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular embodiments are described herein, many variations and permutations of these embodiments fall within the scope of the disclosure. Although some benefits and advantages of the embodiments are mentioned, the scope of the disclosure is not intended to be limited to particular benefits, uses, or objectives. Rather, aspects of the disclosure are intended to be broadly applicable to different technologies, system configurations, networks, and protocols, some of which are illustrated by way of example in the figures and in the following description of the embodiments. The detailed description and drawings are merely illustrative of the disclosure rather than limiting, the scope of the disclosure being defined by the appended claims and equivalents thereof.

Certain devices, such as those described herein, may perform video conferencing by transmitting and receiving video information (e.g., video data or media data) over a communications network. Video conferencing generally refers to at least one user device (e.g., a mobile device, smart phone, or tablet) transmitting video information to another user device. For example, video conferencing may be performed by one user device streaming real-time video information to another user device and also by two or more user devices transmitting video information to each other. In certain circumstances, the communication network may have insufficient bandwidth to support video conferencing, thereby causing the image quality of the received video information to become degraded. In other circumstances, such as where the communication network is a wireless network, a wireless user device may have a poor connection to the wireless network, thereby causing the image quality of the received video information to be degraded.

Some solutions to video conferencing image quality degradation include automatic region of interest (ROI) detection and related encoding strategies. Methods for ROI detection in video conferencing may include image-based foreground segmentation, motion detection, and face detection. Once the ROI is detected, modified rate control schemes are used to allocate more bandwidth to the region of interest during encoding. For example, an encoder may compress portions (e.g., regions) of the image outside of the ROI more than portions of the image inside the ROI. As such, the bitrate of the encoded video information may be sufficiently reduced in order for the encoded video information to be transmitted across the communication network without degrading of the image quality of the video information.

However, automatic ROI detection schemes may not always be capable of determining the true region of interest of a user (e.g., viewer of video information). For example, a face detection scheme may be tricked by a photograph, or if multiple faces are present, may not identify the speaker or person of interest to the user. Or in some situations, the user may be interested in an object of the video information, other than a person, at a given time. Also, some ROI detection schemes do not take into account the depth of objects in the scene. Depth information (e.g., depth maps of the video images) may indicate a distance of an object or region represented in the video image from a view point. Depth information may be used for ROI detection, foreground and background segmentation, and tracking of the objects of interest.

Visual saliency may also be used in ROI detection. Visual saliency is a measure of the importance or distinctiveness of an object compared to other neighboring objects. For example, a more salient object may “pop-out,” or appear more distinct, compared to other neighboring objects, thereby attracting the visual attention of a viewer. Visual salience characteristics may include edge information, local contrast, face/flesh-tone detection, and motion information. The ROI may be detected and tracked using depth information and visual salience as described below.

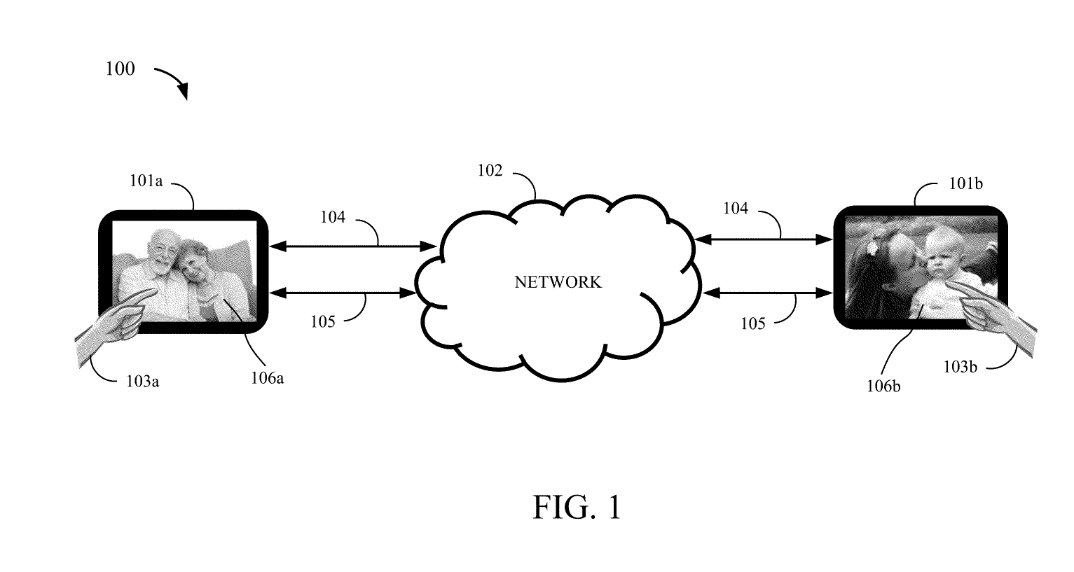

FIG. 1 shows a video conferencing system 100 comprising a first user device 101a and a second user device 101b configured to perform video conferencing. The user devices 101 may be mobile devices, smart phones, or tablets, for example. Each user device 101 may be configured to connect to the other user device 101 through a communication network 102. The communication network 102 may be a wireless communication network. The user devices 101 may be configured to transmit video information (e.g., video or media data) to the other user device 101 over a media channel 104 of the communication network 102. The user devices 101 may also be configured to receive the video information over the media channel 104 and playback the video information on a display 106. The user devices 101 may also be configured to transmit feedback information based on a user interaction over a feedback channel 105 of the communication network 102.

In one embodiment, the second user device 101b may transmit video information to the first user device 101a. The video information may be real-time streaming video information being captured by a video camera of the second user device 101b for example. The video information may be transmitted by the second user device 101b over the media channel 104 of the communication network 102. The first user device 101a may receive the video information over the media channel 104 and display the video information to a first user 103a. In some embodiments, the bandwidth of the media channel 104 may be insufficient to carry the entire video information being transmitted by the second user device 101b, thereby causing the image quality of the video information to degrade. The first user 103a (e.g., viewer) of the first user device 101a may perform a user interaction, such as a touch or gesture, to indicate an object or region of an image of the received video information that they would like to see with improved quality.

The first user device 101a may transmit feedback information to the second user device 101b over a feedback channel 105 of the communication network 102. The feedback information may comprise an indication of the user interactions (e.g., touch or gesture). The feedback information may also comprise regional information identifying the region of an image of the video information touched or gestured to by the first user 103a. The region identified by the first user 103a may include content of the video information or a physical object in the video information. The regional information indicates regions of the video information that define content of the video information or physical objects of the video information. In other embodiments, a second user 103b of the second user device 101b may perform a user interaction in order to provide feedback information to the second user device 101b.

In one embodiment, the user interaction may be a touch input. In other embodiments the user interaction may be pointing or gesturing by the user 103. For example, the first user 103a of the first user device 101a may touch one or more points on the user device 101a. The one or more points touched by the first user 103a may correspond to a region of interest of the first user 103a (e.g., image locations or regions of the video information that are important to the first user 103a). The first user device 101a may comprise a sensor (not shown) configured to detect the user interaction, which is described in further detail below. For example, in response to the first user 103a touching the first user device 101a, the first user device 101a may send feedback information including regional information indicating the x and y coordinates in the image that was touched over the feedback channel 105 to the second user device 101b. The coordinates may define content of the video information or an object of the video information. Using touch input may be efficient in the case of mobile user devices 101 because touch input may not require any significant additional processing by user devices 101 that use touch displays. Touch input is also efficient because users 103 may be sitting close to the user device 103 and the users 103 may already be used to interacting with the user device 103 through touch input.

The second user device 101b may receive the feedback information and adjust pre-processing and encoding of the video information to reduce the bitrate of the transmitted video information based on the feedback information. As such, the first user device 101a provides feedback information to the second user device 101b in order to receive video information that provides improved quality in the regions of the video information indicated by the first user's 103a interaction.

To minimize user interaction, once feedback information on an initial region of the image is received by the second user device 101b, segmentation and tracking methods may be used by the second user device 101b to track the region of interest over time. In another embodiment, the first user 103a may change the region of interest by touching a different location in the image. The user devices 101 may also be configured to allow users 103 to use more than one touch point to select a region of interest. The user devices 101 may also support the users 103 selecting a region of interest by drawing an outline on the image of the video information.

As described above, scarcity of bandwidth, especially for mobile user devices 101, may require that bit rate of the video information be reduced in order for uninterrupted transmission of the video information to occur. For example, the bit rate of the video information may be reduced by reducing the spatial resolution of the video image, by reducing the amount of colors used in the video image, by blurring the video image, or by reducing a frame rate of the video information. Providing feedback information indicating regional information as described above solves the problem of video quality degradation in low bandwidth video conferencing by allowing the user 103 to interactively and dynamically determine the region or regions (e.g., regional information) of the video information that are most important at a given time. The user device 101b transmitting the video information may use the regional information received over the feedback channel 105 to determine the ROI corresponding to the users input. The transmitting user device 101 may then modify its video transmission rate control schemes to allocate more bandwidth to the video image in the ROI, thereby reducing the bit rate of the video. For example, the user device 101 transmitting the video information may process and encode the video information based on the feedback information such that less important regions of the video information are more compressed than more important regions, thereby reducing the overall bitrate of the transmitted video information as described in further detail below.

In another example, the first user 103a may control the quantization parameters for the foreground region and a background region of the video information using the slider. A value set using the slider may be transmitted by the first user device 101a as feedback information to the transmitting second user device 101b. In this embodiment, the first user 103a may specify the region of interest as described above. In another example, the region of interest, may be used by a server (not shown) to determine which portion of video information to encode. The server may be configured to capture a larger field of view at a higher resolution and may interactively adjust the region of the video information that is transmitted (e.g., streamed) to the first user device 101a.

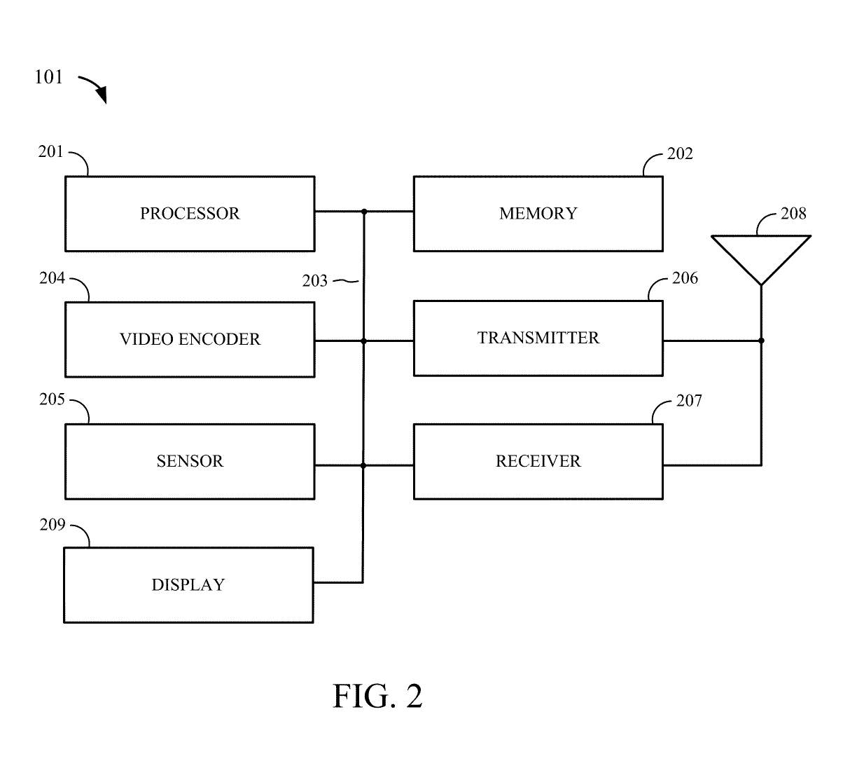

FIG. 2 shows a functional block diagram of components that may be utilized in the user device 101 of FIG. 1 to perform interactive quality improvement for video conferencing. The components described below may provide the user device 101 with the capability to transmit, receive, and display video information, provide feedback information, and pre-process and encode the video information based on saliency information and depth information. The user device 101 may comprise a processor 201 that is configured to control operations of the user device 101. The processor 201 may be configured to determine depth-based saliency information for the video information based on feedback information and depth information as further described below. The depth-based saliency information may be used in pre-processing and encoding the video information in order to provide higher image quality in the more salient regions of the video information.

The processor 201 may be implemented with any combination of processing circuits, general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processor 201 may be configured to execute instruction codes (e.g., in source code format, binary code format, executable code format, or any other suitable format of code). The instructions, when executed by the processor 201, may perform interactive quality improvement for video conferencing as described herein.

The user device 101 may also comprise a memory unit 202 coupled to the processor 201 via a bus system 203. The bus system 203 may be configured to couple each component of the user device 101 to each other component in order to provide information transfer. The memory unit 202 may be configured to store the video information, feedback information, regional information, depth information, saliency information, depth-based saliency information, and other information or data described herein. The memory unit 202 may comprise both read-only memory (ROM) and random access memory (RAM) and may provide instructions and data to the processor 201. A portion of the memory unit 202 may also include non-volatile random access memory (NVRAM). The processor 201 may be configured to perform logical and arithmetic operations based on instructions stored within the memory unit 202.

The user device 101 may also comprise a video encoder 204 coupled to the bus system 203. The video encoder 204 may be configured according to an encoding standard (e.g., AVC/H.264, HEVC/H.265, VP9, etc.). The video encoder 204 may be configured to encode the video information based on depth-based saliency information. For example, the video encoder may be configured to increase quantization parameters for less salient regions of the video information in order to yield larger quantization step sizes, resulting in the use of fewer bits at the cost of lower image quality. The video encoder 204 is described in further detail below.

The user device 101 may also comprise a sensor 205 coupled to the bus system 203. The sensor 205 may be configured to detect the user interaction of the user 103 described above. The sensor 205 may comprise, for example, a video camera, a haptic sensor, an optical sensor, an infrared sensor, an accelerometer, or a gyroscope. The sensor 205 may include several sensors configured to detect different types of user interactions, including touches, movement, rotation, pointing, and gesturing. The sensor 205 may be configured to detect the sensed inputs and determine regional information corresponding to the points or regions of the video information that was touched or gestured to by the user 103. The regional information may be included in the feedback information as described herein.

The user device 101 may also comprise a transmitter 206 and a receiver 207 coupled to the bus system 203. The transmitter 206 and the receiver 207 may be configured to allow for transmission and reception of data between the user device 101 and a remote location. The transmitter 206 may be configured to transmit video information over the media channel 104 of the communication network 102 described above. The transmitter 206 may also be configured to transmit feedback information over the feedback channel 105 of the communication network 102 as described above. The receiver 207 may be configured to receive video information over the media channel 104 and receive feedback information over the feedback channel 105. The transmitter 206 and the receiver 207 may be combined into a transceiver. The user device 101 may also comprise an antenna 208 electrically coupled to the transmitter 206 and the receiver 207. The antenna 208 may be configured for wireless transmission and reception of data over a wireless communication network. The user device 101 may also include multiple transmitters 206, multiple receivers 207, multiple transceivers, and/or multiple antennas 208.

The user device 101 may also comprise a display 209 coupled to the bus system 203. The display 209 may be configured to display video information (e.g., video information stored in the memory unit 202 or video information received by the receiver 207). The display 209 may comprise a liquid crystal display or a light emitting diode display, for example. The sensor 205 may be a touch sensor corresponds to the display 209 such that the sensor detects the user 103 touching the display 209. Although a number of separate components are shown in FIG. 2, one or more of the components may be combined or commonly implemented. Further, each of the components shown in FIG. 2 may be implemented using a plurality of separate elements.

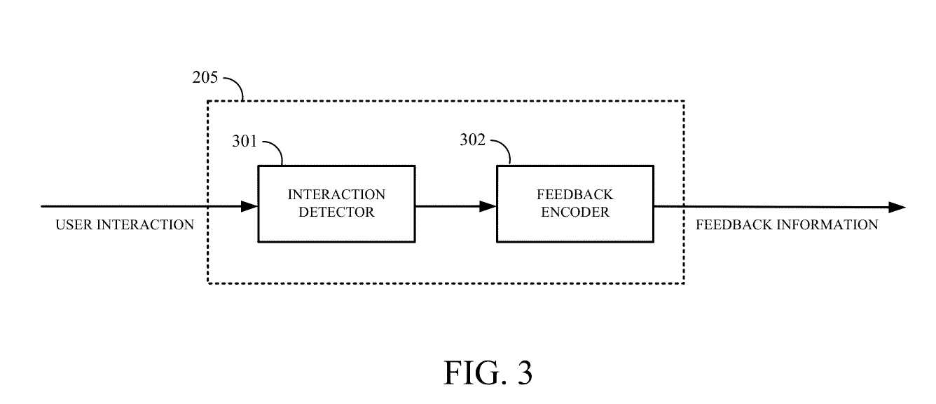

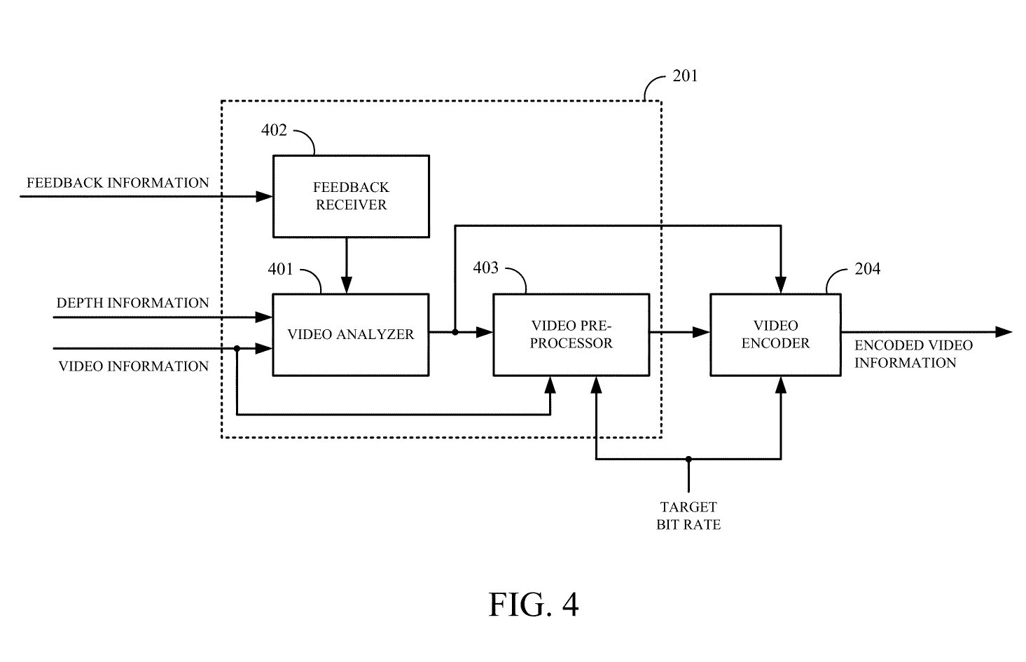

FIG. 3 shows a functional block diagram of the sensor 205 of FIG. 2 for detecting a user interaction and providing feedback information. The sensor 205 may comprise an interaction detector 301 configured to detect an interaction (e.g., touch or gesture) of the user 103 as described above. The interaction detector 301 may be configured to provide an indication of the detected user interaction to a feedback encoder 302. The feedback encoder 302 may be configured to encode feedback information based on the user interaction. For example, the user interaction may include a touch input and the feedback encoder 302 may encoded the feedback information as an x and y coordinate location that indicates an ROI of a user 103. In another example, the user 103 may outline a region of the video image to select the ROI. In this example, the feedback encoder 302 may encode the feedback information to correspond to the outline of the region. For example, the feedback encoder 302 may encode the feedback information to comprise control points representing a curve outlining the region or the centroid and size of the selected region. As such, the feedback information indicates regional information (e.g., x and y coordinate location, outlined region, and centroid) of the video image indicated by the user 103. The sensor 205 may provide the feedback information to the transmitter 206 for transmitting to the second user device 101, as further described below with reference to FIG. 4.

The sensor 205 may be any appropriate sensor to detect the user interaction. For example, the interaction detector 301 of the sensor 205 may comprise a video camera, a haptic sensor, an optical sensor, an infrared sensor, an accelerometer, or a gyroscope. The sensor 205 may also be configured to generate the initial region of interest (e.g., regional information) or to shift the region of interest once an initial location is found. For example, a gyroscope sensor may be configured to shift a point of interest as the user device 101 is tilted in a particular direction or a video camera may be used to determine a location pointed to by the user 103.

FIG. 4 shows a functional block diagram of the processor 201 of FIG. 2 for receiving feedback information, depth information, video information, and the video encoder 204 providing encoded video information. The processor 201 may be configured to determine depth-based saliency information based on the received feedback information, depth information, and video information. The processor 201 and the video encoder 204 may use the depth-based saliency information in pre-processing the video information and encoding the video information, respectively, in order to provide improved image quality in the region of interest.

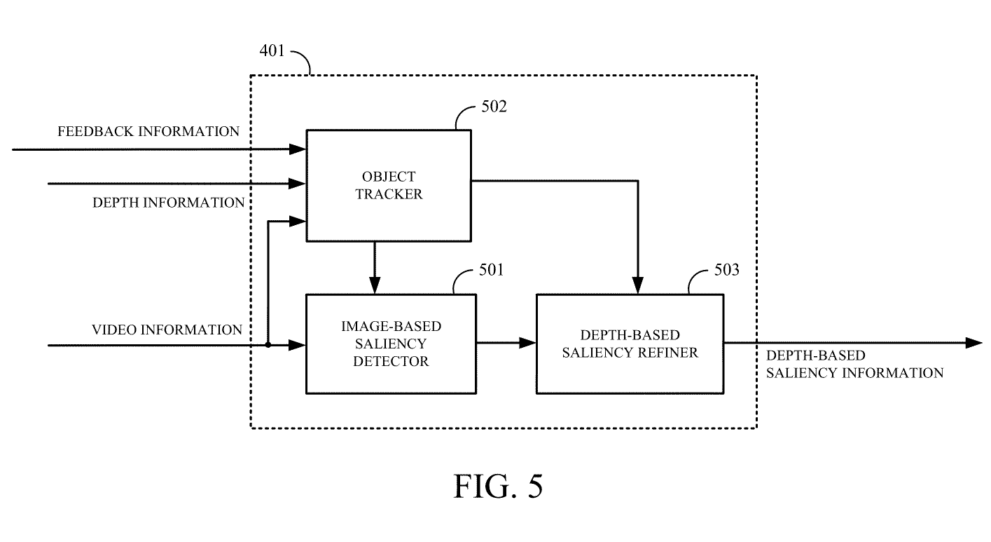

The user device 101 may comprise a video analyzer 401 configured to receive video information and depth information corresponding to the video information. The video information and the depth information may be stored on the memory unit 202 as described above. The video information may also be received from a video camera of the user device 101. The processor 201 may also comprise a feedback receiver 402 configured to receive the feedback information. The feedback receiver may receive the feedback information from the memory unit 202, the sensor 205, or the receiver 207. For example, the feedback information may be received from the first user device 101a over the feedback channel 105 as described above. The feedback information may comprise regional information corresponding to a region of interest as described above. The feedback receiver 402 may provide the regional information to the video analyzer 401. As described in detail below with reference to FIG. 5, the video analyzer 401 may be configured to use the regional information and depth information to determine depth-based saliency information.

In one embodiment, the depth information received by the video analyzer 401 may be provided by a depth camera (e.g., structured light, time-of-flight) or may be determined from a multi-view video input (e.g., stereoscopic camera setup) or may be determined based on image analysis of the video input (e.g., depth extraction methods for 2D to 3D conversion). For further information about converting 2D monocular video into stereoscopic video, reference is made to U.S. patent application Ser. No. 13/725,710 to Sanderson et al. filed Dec. 21, 2012, which is hereby incorporated by reference in its entirety. The video analyzer 401 may use the depth information, provided by the depth-based camera or through depth detection methods, to perform segmentation and tracking of objects in the video information as further described below with reference to FIG. 5. The video analyzer 401 may also use the depth information to determine encoding and pre-processing parameters for the video information. The video analyzer 401 may use the depth information to determine the boundary of an object selected by a user interaction. The video analyzer 401 may also use the depth information to perform depth-based saliency detection and pre-processing of the video information in order to reduce the overall required bandwidth of the encoded video information. The video analyzer 401 and depth-based saliency detection are described in further detail below with respect to FIG. 5.

As described above, the feedback receiver 402 is configured to provide the regional information to the video analyzer 401 and the video analyzer 401 is configured to receive the regional information, the video information, and the depth information. The video analyzer 401 is configured to determine depth-based saliency information and provide pre-processing parameters based on the depth-based saliency information to a video pre-processor 403. The video pre-processor 403 may be configured to filter each region of the video information according to the pre-processing parameters.

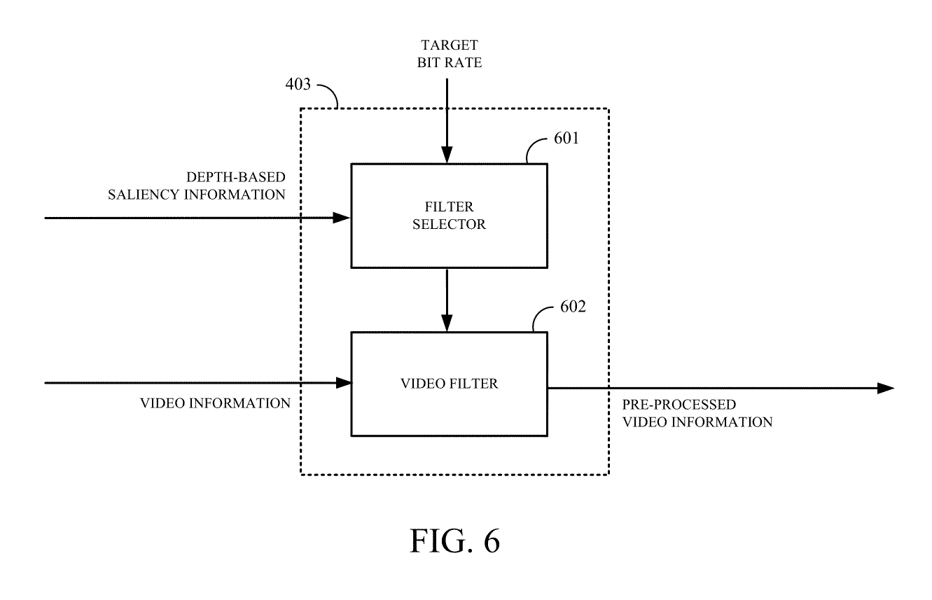

The video pre-processor 403 is configured to pre-process the video information for transmission prior to encoding of the video information by the video encoder 204. The pre-processor 403 may filter the video information such that the region of interest is less compressed than other areas. The pre-processor 403 may filter areas outside of the region of interest to ensure a higher level of compression by inducing a lower level of detail. The level of detail in a particular area of the video information may also be adapted based on the depth-based salience in addition to the feedback information. For example, the video pre-processor 403 may process regions of the video information indicated as more salient by the depth-based saliency information to have less compression (e.g., higher quality and more detail) than less salient regions. As such, the video pre-processor 403 may provide pre-processed video information. The video pre-processor 403 may also be configured to receive and consider a target bit rate and may pre-process the video information based on the target bit rate. The target bit rate may be determined based on conditions of the communication network 102 for transmitting the encoded video information. For example, the target bit rate may be determined based on channel feedback received from the first user device 101a. The video pre-processor 403 is described in further detail below with reference to FIG. 6.

The video encoder 204 may be configured to receive the depth-based saliency information from the video analyzer 401, the pre-processed video information from the video pre-processor 403, and the target bit rate. The video encoder 204 may be configured to determine video encoding parameters for encoding the pre-processed video information based on the depth-based saliency information. The video encoder 204 may be configured to encode the video information using the determined encoding parameters. As described above, the depth-based saliency information may indicate the ROI of the user 103. The video encoder 204 may determine encoding parameters that encode the region of interest at a lower compression level and may encode regions outside of the region of interest at a higher compression level. For example, the video encoder 204 may allocate more bandwidth (e.g., more bits) for the video images in the ROI and allocate less bandwidth (e.g., fewer bits) to the video images outside of the ROI. As such, the encoded video information encoded by the video encoder 204 may be optimized for bandwidth efficiency and may provide improved image quality for the region of interest, even in low bandwidth situations. In some embodiments, in addition to optimizing for bandwidth efficiency, the video encoder 204 may also optimize for decoder complexity by using less complex methods (e.g., no sub-pixel motion estimation, no deblocking, etc.) to encode the less important regions of the image. This may contribute to reducing the power consumption of the video encoder 204 as well as to reducing the encoding/decoding time of the video encoder 204.

In some embodiments, the video encoder 204 may be configured to encode the pre-processed video information based on the target bit rate. The video encoder 204 may be configured to generate encoded video information having a bit rate that does not exceed the target bit rate. For example, the video encoder 204 may be configured to constrain the encoding parameters at a region level based on the depth-based saliency information provided by the video analyzer 401. In another example, the video encoder 204 may encode regions of the video information that are less salient using Skip or Direct coded macroblocks that use less bits (at the cost of less visual quality). Skip and Direct coded macroblocks may avoid residual coding and instead rely on prediction from previously coded images. In one embodiment, the video encoder 204 may use residual coding and increase the quantization parameters of less salient regions in order to yield larger quantization step sizes, resulting in the use of fewer bits at the cost of lower picture quality.

FIG. 5 shows a functional block diagram of the video analyzer 401 of FIG. 4 for determining depth-based saliency information based on the feedback information. The video analyzer 401 comprises an image-based saliency detector 501 configured to receive the video information. The image-based saliency detector 501 is configured to determine image-based saliency information for the video input. For example, the image-based saliency detector 501 may assign an image-based saliency map to the input video information. The saliency map indicates importance values (e.g., salience information) for each region of the input video information. In some embodiments, the saliency map may provide the same spatial and temporal resolution as the video information. As such, the image-based saliency map assigns saliency (e.g., importance) values to each pixel of the video information. The image-based saliency detector 501 may be configured to determine the image-based salience of a particular pixel based on the characteristics of the video information, such as edge information, local contrast, face/flesh-tone detection, and motion information.

The video analyzer 401 may also comprise an object tracker 502 configured to receive the feedback information, the depth information, and the video information. The object tracker 502 may be configured to track the region of interest indicated by the feedback information over time using the depth information. The object tracker 502 may provide object tracking information to the image-based saliency detector 501, the tracking information indicating the movement of the region of interest over time.

The video analyzer 401 may also comprise a depth-based saliency refiner 503 configured to receive the image-based saliency information from the image-based saliency detector 501 and the depth information and object tracking information from the object tracker 502. The depth-based saliency refiner 503 may be configured to combine the image-based saliency information and the depth information to obtain depth-based saliency information. For example, the depth-based saliency refiner 503 may use the following equation (1) to determine depth-based saliency information S_{ID} at a pixel location x of the video information:

S_{ID}(x)=S₁(x)*exp(−k*abs(D₀−d(x))), Equation (1)

where S_{I} represents the image-based saliency (obtained using an image-based saliency detection scheme), k represents the depth-based saliency correction strength, d(x) represents the depth at pixel location x based on the depth information, and D₀ represents the depth of the most salient region (e.g., the region of interest). In equation (1) above, the value of D₀ may be determined by the image-based saliency detector 501 using image-based clues or D₀ may be set to the lowest depth of the scene of the video information. In another embodiment, the feedback information may be used to measure the value of D₀. For example, D₀ may correspond to the depth at the location touched by the first user 103a, or at the centroid of the region indicated by the feedback information. In another embodiment D₀ may correspond to the mean or median depth of the region indicated by the feedback information.

In another embodiment, the depth-based saliency refiner 503 may segment the depth information (e.g., depth image or depth map) into separate layers (e.g., regions) of different depths. The depth-based saliency refiner 503 may determine the depth for each layer based on a mean depth value or a median depth value of the layer. The depth-based saliency refiner 503 may determine the most salient layer to be the layer indicated by the feedback information (e.g., the ROI). The depth-based saliency refiner 503 may determine the depth-based saliency of other regions based on a distance from the most salient layer, where the distance can be measured as a combination of the distance in depth as well as the horizontal and vertical distance in the image plane.

In some embodiments, the depth-based saliency refiner 503 may perform segmentation in the input video information domain based on the depth information. For example, the depth-based saliency refiner 503 may use (R,G,B,x,y,z) or (Y,U,V,x,y,z), as the coordinate of a given pixel, where R,G,B corresponds to red, green, and blue color components of the input video information, x and y correspond to the horizontal and vertical pixel location coordinates in the video information, z corresponds to the depth value, Y corresponds to a luminance color component of the video information, and U and V correspond to chrominance color components of the video information. As such, the depth-based saliency refiner 503 may provide improved object segmentation compared to a system based only on depth. For further information about deriving depth maps, reference is made to U.S. Pat. No. 7,489,812 to Fox et al. (2009), which is hereby incorporated by reference in its entirety.

As described above, the object tracker 502 may track the region of interest indicated by the feedback information over time. This allows the temporal resolution of the feedback information to be smaller than that of the encoded video information. For example, the receiving first user 103a or the transmitting second user 103b may point to a particular object in a scene of the video information and the object may tracked by the object tracker 502 until it leaves the scene, or until the user 103 selects a different region. The object tracker 502 may also use clustering/segmentation information in the (R,G,B,X,Y,Z) domain and therefore may re-use information that is already available from the saliency detection processes described above. If the object tracker 502 does not receive the feedback information, the object tracker 502 may default to a pre-specified detection scheme that may use other information, such as objects that are closest to the camera, or an image-based face detection scheme to determine the most salient region. For further information about object tracking, reference is made to Yilmaz et al. “Object Tracking” ACM Computing Surveys 38.4 (2006), which is hereby incorporated by reference in its entirety.

FIG. 6 shows a functional block diagram of the video pre-processor 403 of FIG. 4 for providing pre-processed video information based on the depth-based saliency information. The video pre-processor 403 may comprise a filter selector 601 configured to receive the target bit rate and the depth-based saliency information from the video analyzer 401. The target bit rate may be determined by the processor 201 based on the conditions of the network 102 used to transmit and receive the video information. The filter selector 601 may be configured to select filtering parameters for filtering the video information based on the depth-based saliency information. For example, the filter selector 601 may select filtering parameters that apply a weaker filter to more salient regions of the video information (e.g., the region of interest) and a stronger filter to less salient regions of the video information, thereby reducing the quality of the video information in less salient regions.

In one embodiment, the filter selector 601 may select filtering parameters that include cutoff frequencies for a set of low pass filters. The low pass filters may be applied at a pixel or region level on the video information based on the depth-based saliency of the corresponding pixel or region. In some embodiments, the filter selector 601 may normalize the depth-based saliency information (e.g., saliency map values) to lie in the range [0, 1] and compute the frequency cutoff (f_{c}) at pixel location x using equation (2):

f_{c}(x)=S(x)/(A*abs(1+ε−S(x))), Equation (2)

where S(x) represents the normalized depth-based saliency information (e.g., saliency map value) at location x, A is a constant that represents the “depth-of-field” in the video information, and ε is a small positive constant to avoid division by zero. In equation (2), larger values of A may lead to a smaller depth-of-field. In other embodiments, the video selector 601 may use other functions of the saliency map to determine the cut-off frequency. In another embodiment, the filter selector 601 may clamp a minimum cutoff frequency in order to not over filter the input video information.

In some embodiments, the filter selector 601 may alter the filtering parameters based on the target bit rate (e.g., available bandwidth for encoding). For example, the filter selector 601 may alter equation (2) above such that the value of A is based on the target bit rate. In equation (2), larger values of A may lead to more blurring (e.g., stronger filtering) in less-salient regions of the video information while smaller values of A may lead to less blurring (e.g., weaker filtering) in less-salient regions. The amount of blurring that is applied to less-salient regions may be based on the target bit rate for encoding and transmitting the video data.

The video pre-processor 403 may comprise a video filter 602 configured to receive the video information and the filtering parameters selected by the filter selector 601. The video filter 602 may be configured to pre-process (e.g., filter) the video information based on the filtering parameters. For example, the video filter 602 may comprise the set of low pass filters configured to filter the video information based on cutoff frequencies provided by the filter selector 601. The video filter 602 may provide the pre-processed (e.g., filtered) video information to the video encoder 204.

In some embodiments, the bandwidth of the communication network 102 may be lower than a specified threshold and the filter selector 601 may eliminate (e.g., set to a fixed color such as gray) regions of the video information having lower depth-based saliency values. In this embodiment, only the more salient regions may be encoded by the video encoder 204. The filter selector 601 may eliminate the regions of the video information with lower saliency in order to minimize the bits used for encoding. In another embodiment, the video encoder 204 may modify the temporal resolution of the regions of the video information based on the saliency map in order to reduce the bit rate. For example, the video encoder 204 may update image regions of the video information with lower saliency at a lower temporal rate than image regions with higher saliency.

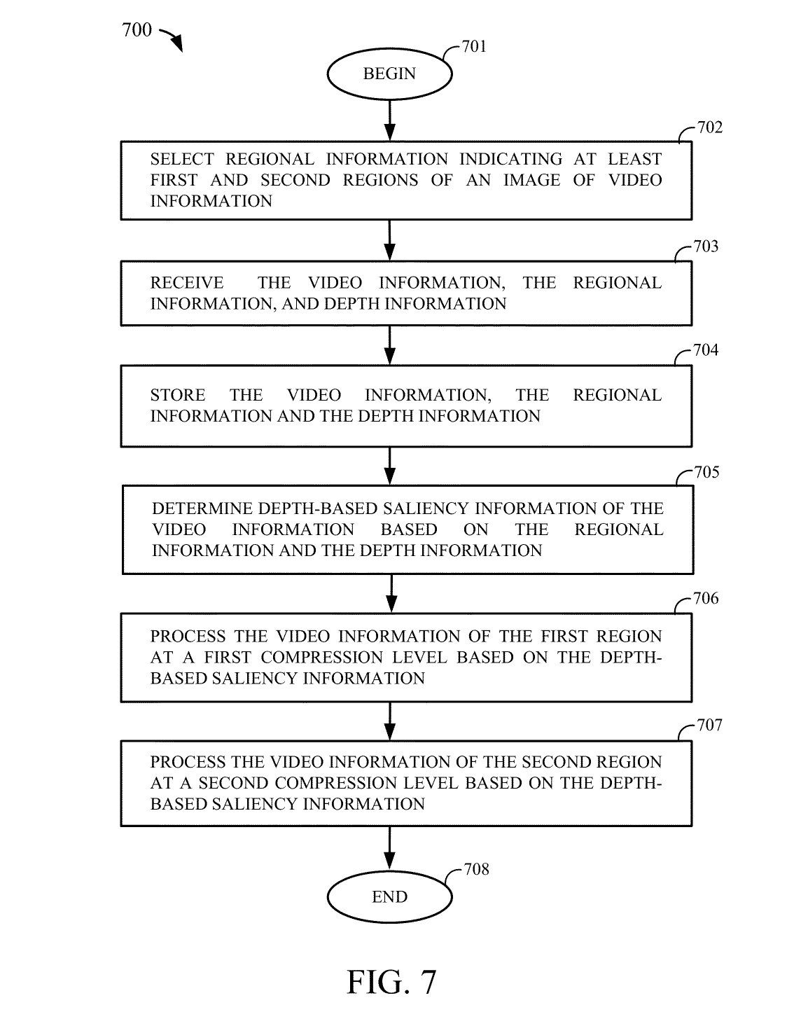

FIG. 7 shows a flow chart 700 of a method for communicating video information to a display device. At step 701 the method begins. At step 702 the method may select regional information indicating at least first and second regions of an image of video information. As described above, the regional information may be indicated by feedback information generated by the sensor 205 based on a user interaction. At step 703 the method may receive the video information, the regional information, and depth information. At step 704 the method may store the video information, the regional information and the depth information. The video information, regional information, and depth information may be stored in the memory unit 202 described above.

At step 705 the method may determine depth-based saliency information of the video information based on the regional information and the depth information. The depth-based saliency information may be determined as described above with reference to FIG. 5. At step 706 the method may process the video information of the first region at a first compression level based on the depth-based saliency information. The processing of the video information may include filtering and encoding of the video information as described above. For example, the first region may have a weaker filter applied to it by the video pre-processor 403 and may be encoded at a higher bit rate by the video encoder 204 as described above. At step 707 the method may process the video information of the second region at a second compression level based on the depth-based saliency information. For example, the second region may have a stronger filter applied to it or be set to a fixed color by the video pre-processor 403 and may be encoded at a lower bit rate by the video encoder 204 as described above. At step 708 the method ends.

Although the above description relates to a video conferencing system, some aspects of this invention are applicable to a single user real-time video streaming system where in the video transmission occurs in only one direction and the video is encoded on-the-fly. Some aspects of this invention may be used in a non-real-time video streaming system wherein the video is pre-encoded and stored on a server. In non-real-time video streaming systems, multiple encoded versions of the video data may be stored at the server corresponding to multiple bit rates and multiple salient regions. For example, the server may store several encoded versions of the content that use different pre-processing/encoding strengths for different objects in the image. In a non-real-time video streaming system a corresponding encoded bitsteam may be provided to the receiving user based on the receiving user's salient region preference and the receiving user's available bandwidth. Based on the user input, the preferred version will be adaptively chosen by the client and requested from the server.

Information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. An apparatus for communicating video information, the apparatus comprising:
a memory unit configured to receive and store regional information, selected at a display device, indicating at least first and second regions of an image of the video information and depth information of the video information; and
a processing circuit configured to determine depth-based saliency information of the video information based on the regional information and the depth information, process the first region at a first compression level based on the depth-based saliency information, and process the second region at a second compression level based on the depth-based saliency information, wherein a first image quality of the first compression level is higher than a second image quality of the second compression level.

2. The apparatus of claim 1, wherein the processing circuit is further configured to receive feedback information indicating the first region from a user of the display device over a communication network.

3. The apparatus of claim 1, wherein each of first and second regions define content or physical objects of the video information.

4. The apparatus of claim 1, wherein the processing circuit is further configured to track a motion of an object defined by the first region based on at least one of the video information and the depth information.

5. The apparatus of claim 1, wherein the image of the video information comprises at least one pixel, the depth-based saliency information indicates a saliency level of each pixel, and the processing circuit is further configured to determine the depth-based saliency information based on feedback information.

6. The apparatus of claim 1, wherein the image of the video information comprises at least one pixel and the depth-based saliency information indicates a saliency level of each pixel, and the processing circuit is further configured to adjust the saliency level of each pixel based on a distance from the first region, wherein the distance is based on at least one of a depth value, a horizontal and vertical coordinate, a luminance value, and a chrominance value of each pixel.

7. The apparatus of claim 1, wherein the display device comprises a sensor configured to sense an interaction of a user, and wherein the regional information is based on the interaction of the user.

8. The apparatus of claim 1, wherein the regional information is based on an interaction of a user, the interaction comprising at least one of a touch and a gesture of the user, the interaction indicating at least one coordinate location of the image or an outline of an area of the image.

9. The apparatus of claim 1, wherein the processing circuit is further configured to filter the first region at a first filtering level based on the depth-based saliency information and filter the second region at a second filtering level based on the depth-based saliency information, the first filtering level being weaker than the second filtering level.

10. The apparatus of claim 1, wherein the processing circuit is further configured to filter the first region and the second region based on a target bit rate.

11. The apparatus of claim 1, wherein the processing circuit is further configured to encode the first region and the second region based on the depth-based saliency information to provide encoded video information having a first bit rate that does not exceed a target bit rate.

12. The apparatus of claim 1, wherein the processing circuit is further configured to encode the first region using a first quantization step size and encode the second region using a second quantization step size, the second quantization step size being larger than the first quantization step size.

13. The apparatus of claim 1, wherein the processing circuit is further configured to encode the first region using a first encoding method and encode the second region using a second encoding method, the second encoding method being less complex than the first encoding method.

14. The apparatus of claim 1, wherein the processing circuit is further configured to set the second region to a fixed color for encoding.

15. The apparatus of claim 1, wherein the processing circuit is further configured to lower a second temporal resolution of the second region to be lower than a first temporal resolution of the first region.

16. A method for communicating video information, the method comprising:
receiving and storing regional information, selected at a display device, indicating at least first and second regions of an image of the video information and depth information of the video information;
determining depth-based saliency information of the video information based on the regional information and the depth information;
processing the first region at a first compression level based on the depth-based saliency information; and
processing the second region at a second compression level based on the depth-based saliency information, wherein a first image quality of the first compression level is higher than a second image quality of the second compression level.

17. The method of claim 16, further comprising
receiving feedback information indicating the first region from a user of the display device over a communication network; and
tracking a motion of an object defined by the first region based on at least one of the video information and the depth information.

18. The method of claim 16, further comprising
filtering the first region at a first filtering level based on the depth-based saliency information;
filtering the second region at a second filtering level based on the depth-based saliency information, the first filtering level being weaker than the second filtering level;
encoding the first region using a first quantization step size and a first encoding method; and
encoding the second region using a second quantization step size and a second encoding method, the second quantization step size being larger than the first quantization step size and the second encoding method being less complex than the first encoding method.

19. An apparatus for communicating video information, the apparatus comprising:
means for receiving and storing regional information, selected at a display device, indicating at least first and second regions of an image of the video information and depth information of the video information;
means for determining depth-based saliency information of the video information based on the regional information and the depth information; and
means for processing the first region at a first compression level based on the depth-based saliency information and processing the second region at a second compression level based on the depth-based saliency information, wherein a first image quality of the first compression level is higher than a second image quality of the second compression level.

20. The apparatus of claim 19, wherein the receiving and storing means comprises a memory unit, the determining means comprises a first processing circuit, and the processing means comprises a second processing circuit.
